(19) United States
(12) Patent Application Publication
(10) Pub. No.: US 2005/0091004 A1
(43) Pub. Date: Apr. 28, 2005

(54) SYSTEM AND METHOD FOR CONDITION ASSESSMENT AND END-OF-LIFE PREDICTION

(76) Inventors: ALEXANDER G. PARLOS, COLLEGE STATION, TX (US); OMAR T. RAIS, EL MANK (MO); SUNIL K. MENON, COLLEGE STATION, TX (US)

Correspondence Address: William N. Hulsey III;Hughes & Luce, 1717 Main Street, Suite 2800, Dallas,, TX, 75201, US

(21) Appl. No.: 09/293,536

(22) Filed: Jan. 29, 2001

Related U.S. Application Data
(60) Provisional application No. 60/081,848, filed on Apr. 15, 1998.

(51) Int. Cl. G06F 11/30; G06F 15/00

(52) U.S. Cl. 702/185

(57) ABSTRACT

A condition assessment and end-of-life prediction system that includes a virtual condition assessment instrument and a virtual end-of-life prediction instrument. The virtual condition assessment instrument measures the condition of the equipment and includes a data capture subsystem for sampling a set of analog signals and converting them into digital signals, a model-based component to estimate disturbances and predict an expected response, a signal-based component to process output from the model-based component, a classification component to process output from the signal-based component, a fuzzy logic expert component to combine information from the classification component and the model-based component in order to assess the condition of the equipment, and a condition assessment panel to display the condition of the equipment. The a virtual end-of-life prediction instrument predicts the equipment end-of-life and includes a condition prediction end-of-life prediction component to analyze information from the virtual condition assessment instrument to predict condition and end-of life, a prediction condition and end-of-life uncertainty estimation component to estimate the uncertainty of the condition and end-of-life prediction, and an end-of-life panel for displaying the condition and end-of-life prediction and uncertainty.

### RELATED APPLICATION

This application claims priority under 35 U.S.C. § 119(e)(1) to provisional application No. 60/081,848 filed Apr. 5, 1998.

### TECHNICAL FIELD OF THE INVENTION

The present invention relates generally to systems and method for providing just-in-time maintenance for equipment, and more particularly, to a system and method for providing an assessment of the condition of a piece of equipment or an entire system (i.e., whether maintenance is required) and for providing a prediction for the equipment/system end-of-life.

### BACKGROUND OF THE INVENTION

In manufacturing, power generation, oil & gas production and refining, and milling sectors, the failure of critical components results in lost revenues and emergency maintenance costs. Industry's response to this risk has been to invest heavily in scheduled preventive maintenance. The importance of detecting problems and preventing failures is reflected in the fact that as much as 15% to 40% of manufacturing production cost is allocated to maintenance. Maintenance cost is one of the highest controllable operation costs. A reliable proactive predictor of maintenance requirements of critical equipment would result in industry savings from reduced lost revenues, overtime costs associated with emergency repairs, and disrupted production schedules.

Current Just-in-Time (JIT) maintenance methods have attempted to address these issues. JIT maintenance means taking a piece of equipment off-line for servicing when it needs it, rather than according to a fixed schedule. It is expensive and time consuming to shut down critical equipment like motors, pumps, compressors and generators for maintenance, so plant operators would like to be sure that the equipment needs servicing before they schedule it. Today, maintenance schedules are based on manufacturer's specification test data. Fixed maintenance schedules result in shutting down a piece of equipment before it really needs it, or in continuing to operate one that should be overhauled. They do not take in account equipment operating history, loading profiles, and operating environments. These are some of the key factors that determine equipment life expectancy.

Current technologies typically do not measure the long-term performance and assess the health of equipment while the equipment is operating. Nor is it possible to predict equipment failures well in advance of their occurrence for adequate planning. Experience indicates that most often equipment fails when least expected and quite often immediately after a major overhaul. The life-time benefit that can be derived by a technology capable of assessing and predicting the long-term health of equipment is quite significant.

### SUMMARY OF THE INVENTION

The present invention provides a system and method for condition assessment and end-of-life prediction that substantially eliminates or reduces disadvantages and problems associated with previously developed equipment maintenance systems and methods.

According to one aspect of the present invention, the condition assessment and end-of-life prediction system of the present invention includes two virtual instruments: a virtual condition assessment instrument and a virtual end-of-life prediction instrument. The virtual condition assessment instrument measures the condition of the equipment and includes a data capture subsystem for sampling a set of analog signals and converting them into digital signals, a model-based component to estimate disturbances and predict an expected response, a signal-based component to process output from the model-based component, a classification component to process output from the signal-based component, a fuzzy logic expert component to combine information from the classification component and the model-based component in order to assess the condition of the equipment, and a condition assessment panel to display the condition of the equipment. The a virtual end-of-life prediction instrument predicts the equipment end-of-life and includes a condition prediction end-of-life prediction component to analyze information from the virtual condition assessment instrument to predict condition and end-of life, a prediction condition and end-of-life uncertainty estimation component to estimate the uncertainty of the condition and end-of-life prediction, and an end-of-life panel for displaying the condition and end-of-life prediction and uncertainty.

A technical advantage of the present invention is the use of software programming that uses historical data to indicate when a piece of equipment is out of calibration or in need of service. This technical advantage allows the user of the equipment to minimize down time by eliminating fixed schedule off-line servicing. This eliminates both shutting down a piece of equipment before it really needs it and continuing to operate one that should be overhauled.

Another technical advantage of the present invention is the use of software programming that uses historical data to predict the end-of-life of a piece of equipment. The present invention measures the long-term performance and assesses the health of equipment during operation. This allows a user to (1) predict equipment failures well in advance of their occurrence and (2) only replace equipment that is actually approaching end of life.

The present invention provides yet another technical advantage by providing a reliable proactive predictor of maintenance requirements of critical equipment that results in cost savings due to a reduction in equipment down time, overtime costs associated with emergency repairs, and disrupted production schedules.

### DETAILED DESCRIPTION

Implementation of the condition assessment and end-of-life prediction maintenance technology of the present invention is based on the following technological innovations:

Signal processing algorithms and software programs for: (1) multi-s-ahead (including single-step-ahead) predictor (or forecasting) systems in data-rich and data-scarce environments, (ii) nonlinear disturbance estimators, (iii) nonlinear state filters, and, (iv) the uncertainty associated with the estimates in (i), (ii) and (iii),
Intelligent Condition Assessment and End-of-Life Prediction System (ICAPS) utilizing physical (or hardware) instruments (or sensors) as inputs and inferring the system condition and system end-of-life (or remaining useful life or residual life) as outputs, including the uncertainty associated with these inferences,
Virtual (or software) instruments (or sensors) displaying equipment condition and equipment end-of-life information.

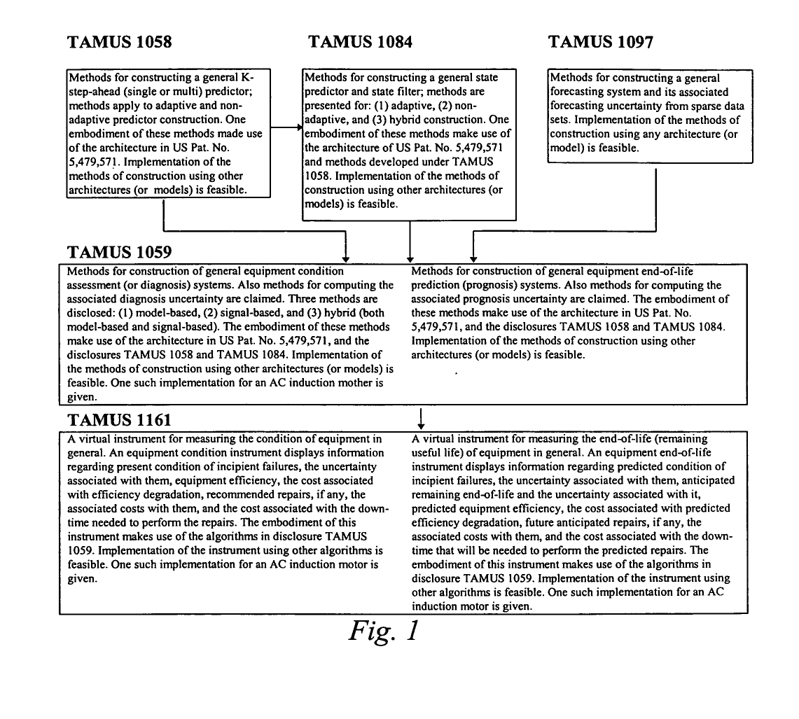

FIG. 1 shows an overview of the invention in broad detail and the interrelation of the various parts of the invention are presented.

Enabling Signal Processing Technology

The signal processing technology at the core of the JIT maintenance technology has been developed over the last ten years.

Neural network software is at the heart of our information processing technology Neural networks are one of the most promising mechanisms to supply reliable and critical timely information. Our neural network's unique ability to learn the characteristics of man-made dynamic systems comes from the introduction of feedback into a conventional feed-forward architecture.

The signal processing developments deal with estimation in nonlinear systems, in general. Algorithms that enable the construction of nonlinear predictors, in general, have been developed. These predictors are appropriate for multi-step-ahead prediction, in general, including single-step-ahead prediction in data-rich environments. The construction methods are applicable to non-adaptive and adaptive predictors. The architectures (or model structures) that this invention can apply to include, but are not limited to, the one presented in U.S. Pat. No. 5,479,571, hereby incorporated by reference in its entirety. TAMUS 1058 presents one embodiment of this invention incorporated into the architecture of U.S. Pat. No. 5,479,571, hereby incorporated by reference in its entirety.

Additionally, algorithms that enable the construction of nonlinear state filters, in general, have been developed. Methods have been developed for the construction of non-adaptive, adaptive and hybrid state filters in data-rich environments, as described in detail later. The architectures (or model structures) that this invention applied to includes, but is not Limited to, the one presented in U.S. Pat. No. 5,479,571. TAMUS 1084 presents one embodiment of this invention incorporated into the architecture of U.S. Pat. No. 5,479,571, hereby incorporated by reference in its entirety.

The last component of the enabling signal processing technology consists of algorithms for the multi-step-ahead prediction (or forecasting) in data-scarce environments. Because the associated uncertainty in data-scarce environments is large, a forecast uncertainty estimation algorithm has also been developed. The architectures (or model structures) that this invention applies to includes, but is not limited to, the one presented U.S. Pat. No. 5,479,571, hereby incorporated by reference in its entirety. TAMUS 1097 presents one embodiment of this invention incorporated into a special form of the architecture in U.S. Pat. No. 5,479,571, hereby incorporated by reference in its entirety.

Intelligent Condition Assessment and End-of-Life Prediction System (ICAPS)

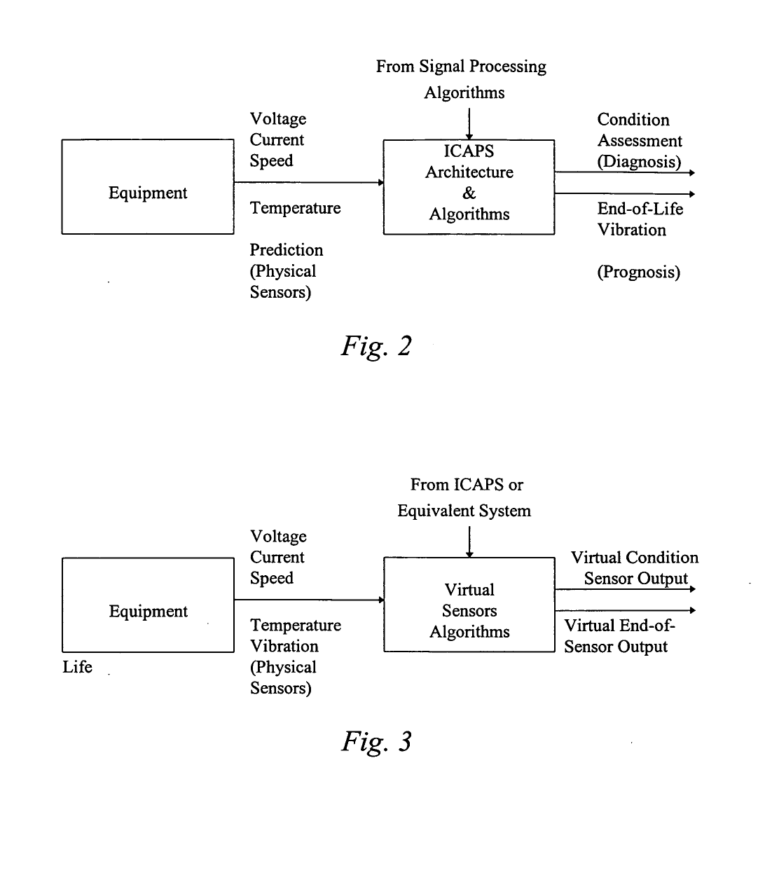

The Intelligent Condition Assessment and End-of-Life Prediction System (ICAPS) consists of a series of signal processing algorithms combined in unique ways to allow: (i) assessment of equipment condition and the associated uncertainty, and (ii) prediction of equipment end-of-life and the associated uncertainty. FIG. 2 shows a system-level description of the Intelligent Condition Assessment and End-of-Life Prediction System. FIG. 2 depicts the ICAPS as receiving inputs from the equipment physical sensors and the signal processing algorithms. The ICAPS can be implemented using signal processing algorithms other than the ones presented in this document. The present embodiment of ICAPS in this document depends on the signal processing technology of TAMUS 1058, TAMUS 1084 and TAMUS 1097, as shown in FIG. 1.

A more detailed description of the operation and implementation of the Intelligent Condition Assessment and End-of-Life Prediction System (ICAPS) is provided A below.

Virtual Instruments (or Sensors) for Measuring Equipment Condition and Equipment End-of-Life

This section relates to the virtual (software) instrument (or sensors) for measuring the long-term equipment condition and equipment end-of-life aspects of the invention. There are no physical (or hardware) sensors that can measure equipment condition or end-of-life directly. Therefore equipment condition and end-of-life measurements must be inferred by other direct (or physical) measurements and by the use of virtual sensors, as shown in FIG. 3.

A more detailed description of the operation and implementation of the Virtual Instruments is provided below.

Virtual Condition Instrument

A virtual equipment condition instrument is defined to be a software system that is connected to a physical piece of equipment through physical (or hardware) sensors and which can accurately, continuously, non-intrusively, and in real-time or in near real-time provide equipment condition information, i.e. provide equipment condition information without the need to disrupt equipment operation and without human intervention. Here condition is broadly defined to reflect (a) the current status of incipient failures and the associated uncertainties, (b) the repairs appropriate for the current status and the costs associated with the (i) direct labor, (ii) parts, and (iii) down-time to accomplish these repairs, (c) the equipment efficiency and the costs associated with the efficiency degradation.

A more detailed description of the operation and implementation of the Virtual Condition Instrument is provided below.

Virtual End-of-Life Instrument

A virtual equipment end-of-life instrument is defined to be a software system that is connected to a physical piece of equipment through physical (or hardware) sensors and which can accurately, continuously, non-intrusively, and in real-time or in near real-time provide equipment end-of-life information, i.e. provide equipment end-of-life information without the need to disrupt equipment operation and without human intervention. Here end-of-life (or remaining useful life or residual life) is broadly defined to reflect (a) expected time to failure and the associated uncertainty, (b) the predicted status of incipient failures, (c) the repairs appropriate for the predicted status and the costs that will be associated with the (i) direct labor, (ii) parts, and (iii) down-time to accomplish these predicted repairs, (d) the predicted equipment efficiency and the costs associated with the predicted efficiency degradation

A more detailed description of the operation and implementation of the Virtual End-Of-Life Instrument is provided below.

The present invention can include the following features:

1. Signal Processing

[1] Adaptive single-step-ahead prediction of measured complex system output variables, where the complex system comprises of nonlinear, stochastic and generally unknown dynamics.
[2] Nonadaptive filtering of unmeasurable (or unmeasured) complex system state variables, where the complex system comprises of nonlinear, stochastic and generally unknown dynamics.
[3] Adaptive filtering of unmeasurable (or unmeasured) complex system state variables, where the complex system comprises nonlinear, stochastic and generally unknown dynamics.
[4] Hybrid (nonadaptive and adaptive) filtering of unmeasurable (or unmeasured) complex system state variables, where the complex system comprises of nonlinear, stochastic and generally unknown dynamics.
[5] Adaptive multi-step-ahead prediction (forecasting) of measured complex system output variables, where the complex system comprises of nonlinear, stochastic and generally unknown dynamics.
[6] Uncertainty estimation (confidence interval computation) of an adaptive multi-step-ahead predictor (forecasting system) of measured complex system output variables, where the complex system comprises of nonlinear, stochastic and generally unknown dynamics.
   2. System Level Diagnosis and Prognosis
[1] Model-based diagnosis of incipient failures in complex systems, where the complex system comprises of nonlinear, stochastic and generally unknown dynamics.
[2] Signal-based diagnosis of incipient failures in complex systems, where the complex system comprises of nonlinear, stochastic and generally unknown dynamics
[3] Hybrid- signal-based and model-based-diagnosis or incipient failures in complex systems, where the complex system comprises of nonlinear, stochastic and generally unknown dynamics.
[4] Decoupling the effects of system inputs and disturbances on the system outputs, from the effects of system incipient faults.
[5] Prognosis of incipient failures and prediction of the end-of-life of complex systems, where the complex system comprises of nonlinear, stochastic and generally unknown dynamics.
[6] Estimating the uncertainty in the end-of-life of complex systems, where the complex system comprises of nonlinear, stochastic and generally unknown dynamics.
   3. System Specific Diagnosis and Prognosis
[1] Model-based diagnosis of incipient failures in electric motors, electric generators of all types (electric machines, in general), electric transformers of all types, electric batteries of all types, electric motor-driven equipment of all types, i.e. pumps, fans, compressors, machine tools, valves, conveyor belts, prime movers of all types, i.e. turbomachinery, diesel engines, internal combustion engines, and process equipment, i.e. boilers, heat exchangers.
[2] Hybrid-signal-based and model-based-diagnosis of incipient failures in electric motors, electric generators of all types (electric machines, in general), electric transformers of all types, electric batteries of all types, electric motor-driven equipment of all types, i.e. pumps, fans, compressors, machine tools, valves, conveyor belts, prime movers of all types, i.e. turbomachinery, diesel engines, internal combustion engines, and process equipment, i.e. boilers, heat exchangers.
[3] Canceling the effects of poor electric power quality from the motor stator current, electric generators of all types (electric machines, in general), electric transformers of all types, electric batteries of all types, electric motor-driven equipment of all types, i.e. pumps, fans, compressors, machine tools, valves, conveyor belts, prime movers of all types, i.e. turbomachinery, diesel engines, internal combustion engines, and process equipment, i.e. boilers, heat exchangers.
[4] Canceling the effects of load torque variations from the motor stator current, electric generators of all types (electric machines, in general), electric transformers of all types, electric batteries of all types, electric motor-driven equipment of all types, i.e. pumps, fans, compressors, machine tools, valves, conveyor belts, prime movers of all types, i.e. turbomachinery, diesel engines, internal combustion engines, and process equipment, i.e. boilers, heat exchangers.
[5] Prognosis of incipient failures and prediction of the end-of-life of electric motors, electric generators of all types (electric machines, in general), electric transformers of all types, electric batteries of all types, electric motor-driven equipment of all types, i.e. pumps, fans, compressors, machine tools, valves, conveyor belts, prime movers of all types, i.e. turbomachinery, diesel engines, internal combustion engines, and process equipment, i.e. boilers, heat exchangers.
[6] Estimating the uncertainty in the end-of-life of electric motors, electric generators of all types (electric machines, in general), electric transformers of all types, electric batteries of all types, electric motor-driven equipment of all types, i.e. pumps, fans, compressors, machine tools, valves, conveyor belts, prime movers of all types, i.e. turbomachinery, diesel engines, internal combustion engines, and process equipment, i.e. boilers, heat exchangers.
   4. Virtual Instrumentation
[1] A virtual instrument or sensor for measuring the condition (or health) of any type of equipment (all equipment categories listed in Section 3) in real-time.
[2] A virtual instrument or sensor for measuring the end-of-life of any type of equipment (all equipment categories listed in Section 3) in real-time.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A system for condition assessment of a piece of equipment comprising:
a virtual condition assessment instrument for measuring a condition of the piece of equipment, comprising:
a data capture subsystem for sampling a set of analog signals and converting the set of analog signals to at least one digital signal;
a model component, comprising:
a filter to estimate disturbances; and
a predictor for predicting an expected response;
a signal-based component for processing output from said model component;
a classification component for processing output from said signal-based component;
a fuzzy logic expert component for combining information from said classification component and said model component to assess the condition of the piece of equipment; and
a virtual end-of-life prediction instrument for measuring an end of life of the piece of equipment, comprising:
a condition prediction end-of-life prediction component for analyzing information from said virtual condition assessment instrument to predict condition and end-of-life of the piece of equipment;
a prediction condition and end-of-life uncertainty estimation component for processing information received from said condition prediction end-of-life prediction component to obtain an estimate of the uncertainty of the condition and end-of-life prediction; and
an end-of-life panel for displaying the condition and end-of-life prediction and uncertainty.
